(19) United States
(12) Patent Application Publication
(10) Pub. No.: US 2011/0093623 A1
(43) Pub. Date: Apr. 21, 2011

(54) Docking Station with Video Control System

(75) Inventor: Johnny CHEN, Santa Ana, CA (US)

(73) Assignee: I/O INTERCONNECT, LTD.

(21) Appl. No.: 12/764,918

(22) Filed: Apr. 21, 2010

(30) Foreign Application Priority Data
Oct. 20, 2009 (TW) 098219303

(51) Int. Cl. G06F 3/00; G06F 13/00

(52) U.S. Cl. 710/14; 710/303

(57) ABSTRACT

A docking station with video control system includes a housing, a USB hub, a VGA to USB video conversion unit, a USB interface controller and a button. The USB hub includes an upstream port and a downstream port. The upstream port is adapted to connect with a USB connector. The USB connector is adapted to connect with a host. The host has a VGA to USB driver including a predetermined video view mode. The VGA to USB video conversion unit has an input port and an output port. The input port couples with the downstream port. The output port couples with a VGA connector. The USB interface controller couples with the USB hub. The button couples with the USB interface controller. If the button is pressed, the VGA to USB driver can be started, so that the predetermined video view mode is selected.

### CROSS-REFERENCE TO RELATED APPLICATION

This application claims the priority benefit of Taiwan application serial no. 098219303, filed on Oct. 20, 2009. The entirety of the above-mentioned patent application is incorporated herein by reference and made a part of this specification.

### BACKGROUND

1. Technical Field

The present invention relates to a docking station with video control system, and more particularly to a docking station that can start a VGA to USB driver to select a predetermined video view mode by pressing a button.

2. Description of the Related Art

Docking stations have been widely used in notebook computers or laptop computers, so that keyboards, mice or large display devices can be connected to use with the notebook computers or the laptop computers. Generally, a connector of the docking station should include a plurality of pins for electrical connection, and each of types of signal, such as stereo signal or VGA video signal, should be transmitted by a specified cable correspondingly. Therefore, the configuration of the docking station is complicated. Recently, in USB 2.0, “high-speed” serial data cable may satisfy the requirement of the various types of signal transmission, and the USB 2.0 can support all signals (including video signal) to be transmitted on the same cable. In use, the video signal that is transmitted to an external display device is controlled by a drawing unit of a personal computer. A user may operate to make the video signal transmit to the external display device by a control panel and/or hotkeys of a keyboard. However, in operation, the user should have some skills about computer software.

What is needed, therefore, is a new docking station that can overcome the above-mentioned shortcomings.

### BRIEF SUMMARY

The present invention relates to a docking station with video control system, which can be used conveniently by a user without some skills about computer software.

The present invention also relates to a docking station with video control system, which can start a VGA to USB driver to select a predetermined video view mode by pressing a button.

The present invention provides a docking station with video control system. The docking station includes a housing, a USB hub, a VGA to USB video conversion unit, a USB interface controller and a button. The housing has a receiving cavity. The USB hub is disposed in the housing and includes an upstream port and a downstream port. The upstream port is adapted to connect with a USB connector. The USB connector is adapted to connect with a host by a cable. The host has a VGA to USB driver including a predetermined video view mode. The VGA to USB video conversion unit has an input port and an output port. The input port couples with the downstream port of the USB hub. The output port couples with a VGA connector. The USB interface controller couples with the USB hub. The button couples with the USB interface controller and is exposed from one receiving cavity. If the button is pressed, the VGA to USB driver can be started, so that the predetermined video view mode is selected.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram of a docking station with video control system according to an embodiment of the present invention.

FIG. 2 is a schematic view of the docking station with video control system connecting with a host and an external display device by a USB cable according to an embodiment of the present invention.

### DETAILED DESCRIPTION

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

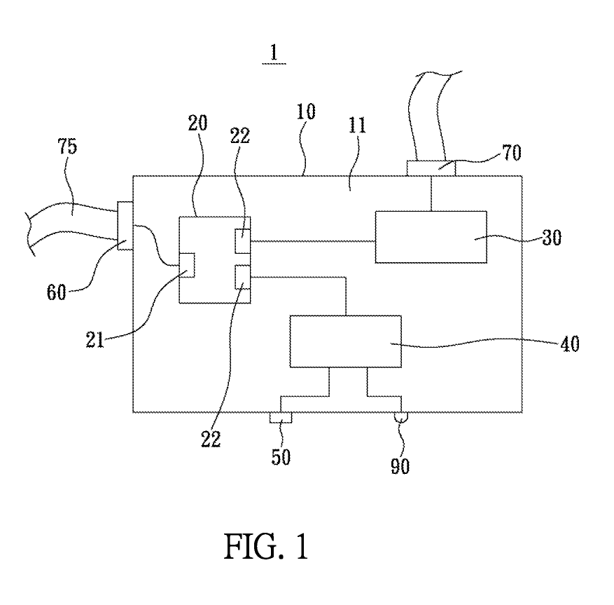

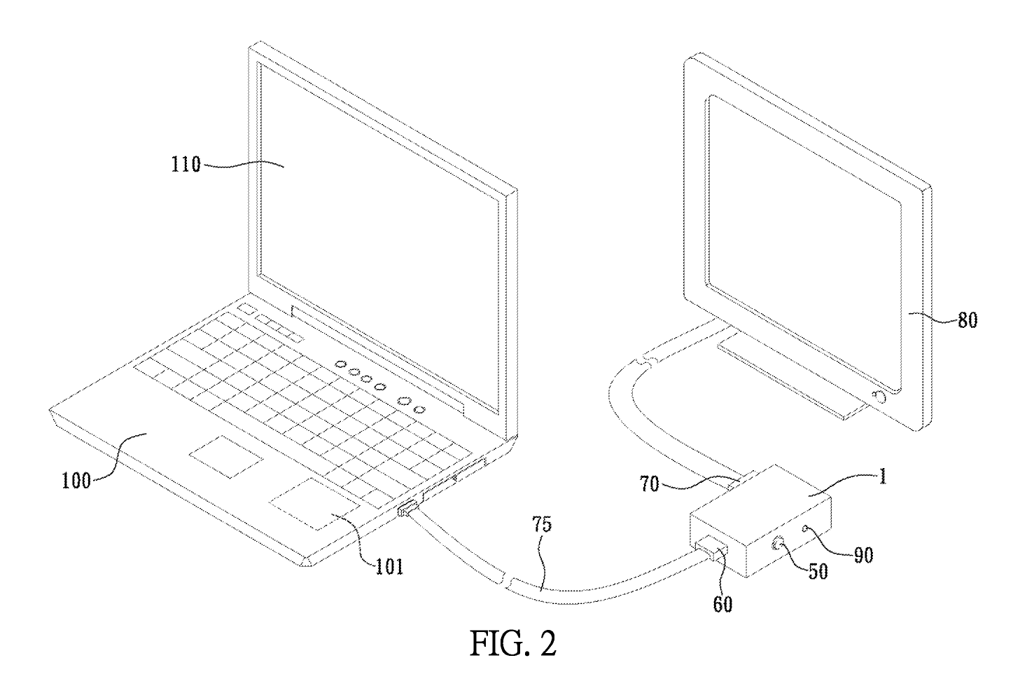

FIG. 1 is a block diagram of a docking station with video control system according to an embodiment of the present invention. FIG. 2 is a schematic view of the docking station with video control system connecting with a host and an external display device by a USB cable according to an embodiment of the present invention.

Referring to FIG. 1, the docking station 1 with video control system includes a housing 10, a USB hub 20, a VGA to USB video conversion unit 30, a USB interface controller 40, at least one button 50, a USB connector 60 and a VGA connector 70.

The housing 10 has at least one receiving cavity 11 for receiving the USB hub 20, the VGA to USB video conversion unit 30, the USB interface controller 40, the at least one button 50. The housing 10 can be made of metal or plastic.

The USB hub 20 is disposed in the housing 10. The USB hub 20 includes an upstream port 21 and two downstream ports 22. In other embodiments, the number of the upstream port 21 can be more than one, and the number of the downstream port 22 can be one or more than two. The upstream port 21 is adapted to connect with the USB connector 60. Also referring to FIG. 2, the USB connector 60 can be connected with a host 100 by a cable 75. The USB connector 60 is exposed from the housing 10. The USB connector 60 can be a B-type USB connector. The downstream ports 22 can be connected with the VGA to USB video conversion unit 30 and the USB interface controller 40 respectively.

The host 100 can be a notebook computer, a portable electronic device or other portable electronic device. In this embodiment, the host 100 is the notebook computer. The host 100 has a VGA to USB driver 101 including at least one predetermined video view mode. The at least one predetermined video view mode can be selected from the group consisting of an extended view mode, a mirror view mode, an external monitor view mode, a flipped extended view mode, a presentation mode and a last-used view mode. In an alternative embodiment, the VGA to USB driver 101 can be stored in a USB storage device (not shown), and the USB storage device can be connected with the downstream port 22. If the host 100 is connected with the docking station 1, the VGA to USB driver 101 will be installed in the host 100 automatically. As such, a CD drive or a DVD drive can be omitted.

The VGA to USB video conversion unit 30 is disposed in the housing 10. The VGA to USB video conversion unit 30 has an input port and an output port. The input port couples with the downstream port 22 of the USB hub 20. The output port couples with the VGA connector 70. The VGA connector 70 can connect to an external display unit 80. The external display unit 80 can be a liquid crystal display device. The VGA to USB video conversion unit 30 can support the DVI standard or the HDMI standard.

The USB interface controller 40 couples with the USB hub 20. The USB interface controller 40 can be configured to detect a state of the at least one button 50, and has a communication interface for communicating between the USB interface controller 40 and the host 100.

The at least one button 50 couples with the USB interface controller 40 and exposed from the receiving cavity 11. The at least one button 50 can start the VGA to USB driver 101. In the embodiment, the at least one button 50 is one, and the present invention is not limited herein.

In addition, the docking station 1 can further include at least one indicating unit 90 coupling with the USB interface controller 40 and exposed from the receiving cavity 11. In the embodiment, the at least one indicating unit 90 includes a single light emitting diode (LED), and the single light emitting diode can flash in a different time to show the different video view mode that is selected correspondingly. In an alternative embodiment, the at least one indicating unit 90 can include a plurality of light emitting diodes, and each of light emitting diodes can show the different video view mode that is selected correspondingly.

In use, the docking station 1 with video control system is connected with host 100 by the USB cable 75, and the external display unit 80 is connected with the VGA connector 70. When the button 50 is pressed, the USB interface controller 40 can detect the pressing state of the button 50 and the host 100 can control the VGA to USB driver 101 to start by the upstream port 21. So that the user can select the predetermined video view mode on a display unit 110 of the host 100. In details, when the extended view mode is selected, video signal is extended, and a portion of the video signal on the left can output to display on a display unit 110 of the host 100 and a portion of the video signal on the right can output to the VGA connector 70 and display on the external display unit 80. When the mirror view mode is selected, the video signal outputting to the VGA connector 70 is the same to that of outputting to the display unit 110 of the host 100. When the external monitor view mode is selected, the display unit 110 of the host 100 is shut off, so as to reduce electrical energy. When the flipped extended view mode is selected, the video signal is extended, and the portion of the video signal on the right can output to display on the display unit 110 of the host 100 and the portion of the video signal on the left can output to the VGA connector 70 and display on the external display unit 80. When the presentation mode is selected, the video signal outputting to the VGA connector 70 is the same to that of outputting to the display unit 110 of the host 100, and a pause function button (not shown) can be further provided. If the pause function button is pressed, the host 100 can be operated, and the operating result on the host 100 can display on the display unit 110 of the host 100 and does not output to the VGA connector 70. When the last-used view mode is selected, the VGA to USB driver 101 can record a video view mode that is used lastly, and if the host 100 is reconnected, the VGA to USB driver 101 will configure the video view mode that is used lastly as the predetermined video view mode. Accordingly, the docking station with video control system of the present invention can be used conveniently by the user without some skills about computer software.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A docking station with video control system, comprising:
a housing having at least one receiving cavity;
a USB hub disposed in the housing and including an upstream port and at least one downstream port, the upstream port connecting with a USB connector, the USB connector connecting with a host by a cable, the host having a VGA to USB driver including at least one predetermined video view mode;
a VGA to USB video conversion unit having an input port and an output port, the input port coupling with the at least one downstream port of the USB hub, the output port coupling with a VGA connector;
a USB interface controller coupling with the USB hub; and
at least one button coupling with the USB interface controller and exposed from the at least one receiving cavity;
wherein if the button is pressed, the VGA to USB driver is capable of being started, so that the at least one predetermined video view mode is selected.

2. The docking station with video control system claimed in claim 1, wherein the host is a notebook computer or a portable electronic device.

3. The docking station with video control system claimed in claim 1, wherein the USB connector connecting with the upstream port is a B-type USB connector.

4. The docking station with video control system claimed in claim 1, further comprising at least one indicating unit coupling with the USB interface controller and exposed from the at least one receiving cavity, the at least one indicating unit showing a video view mode that is selected.

5. The docking station with video control system claimed in claim 4, wherein the at least one indicating unit is a light emitting diode, and the light emitting diode is adapted to flash in a different time to show the different video view mode that is selected correspondingly.

6. The docking station with video control system claimed in claim 4, wherein the at least one indicating unit includes a plurality of light emitting diodes, and each of light emitting diodes shows the different video view mode that is selected correspondingly.

7. The docking station with video control system claimed in claim 1, wherein the at least one predetermined video view mode is selected from the group consisting of an extended view mode, a mirror view mode, an external monitor view mode, a flipped extended view mode, a presentation mode and a last-used view mode.

8. The docking station with video control system claimed in claim 7, wherein in the extended view mode, video signal is extended, and a portion of the video signal on the left is capable of outputting to display on a display unit of the host and a portion of the video signal on the right is capable of outputting to the VGA connector; in the mirror view mode, the video signal outputting to the VGA connector is the same to that of outputting to the display unit of the host; in the external monitor view mode, the display unit of the host is shut off, so as to reduce electrical energy; in the flipped extended view mode, the video signal is extended, and the portion of the video signal on the right is capable of outputting to display on the display unit of the host and the portion of the video signal on the left is capable of outputting to the VGA connector; in the presentation mode, the video signal outputting to the VGA connector is the same to that of outputting to the display unit of the host, and a pause function button is further provided, and if the pause function button is pressed, the host is capable of being operated, and the operating result on the host is capable of displaying on the display unit of the host and does not output to the VGA connector; in the last-used view mode, the VGA to USB driver is capable of recording a video view mode that is used lastly, and if the host is reconnected, the VGA to USB driver will configure the video view mode that is used lastly as the predetermined video view mode.

9. The docking station with video control system claimed in claim 1, wherein the VGA to USB video conversion unit supports DVI standard or HDMI standard.

10. The docking station with video control system claimed in claim 1, wherein the VGA to USB driver is stored in a USB storage device, the USB storage device is connected with the at least one downstream port, and if the host is connected with the docking station, the VGA to USB driver will be installed in the host automatically.
